(19) United States
(12) Patent Application Publication
(10) Pub. No.: US 2024/0254806 A1
(43) Pub. Date: Aug. 1, 2024

(54) LOCK WITH PICK PREVENTION ASSEMBLY AND ALARM

(71) Applicant: JACK COPLEN, FOLSOM, CA (US)

(72) Inventor: JACK COPLEN, FOLSOM, CA (US)

(21) Appl. No.: 18/101,925

(22) Filed: Jan. 26, 2023

(51) Int. Cl. E05B 29/00; E05B 27/00; E05B 45/08

(52) U.S. Cl. CPC E05B 29/0053; E05B 27/0078; E05B 29/0033; E05B 45/08

(57) ABSTRACT

A lock for pick prevention includes a set of cylinder pins aligned in a row in a cylinder. A first set of security pins are in a first carriage assembly. The security pins are aligned to a keyed displacement in cooperation with the set of cylinder pins. A second carriage assembly is positioned angularly displaced from the position of the first carriage assembly. One of the second set of security pins is aligned to the same keyed displacement as a corresponding one of the first set of security pins. An obstructive device is coupled to the second set of security pins, which is disposed to obstruct the cylinder from reaching an unlocked position in the event, a displacement of the second set of security pins does not align with the same keyed displacement as the first set of security pins.

### CROSS-REFERENCE TO RELATED APPLICATION

None.

### FIELD

The subject disclosure relates to locks, and in particular, a lock with a pick prevention assembly.

### BACKGROUND

Locks conventionally include tumblers that have traditionally been susceptible to being breached by the use of lock picks or a technique called bumping. A skilled user, with a set of lock picks, can bypass a lock's security by manipulating the set of pins one at a time until the correct individual pin heights in the cylinder are reached. Once the correct pin height combination is acquired, the cylinder is free to rotate into the unlocking position, moving the bolt or latch.

Some locks have tried to make picking or bumping difficult by introducing unconventional keyed assemblies that deviate from the standard row of pins that accept keys with teeth at different levels. For example, a cross lock uses a cross-shaped key. The tumbler assembly includes one set of pins that are positioned in the traditional vertical alignment and a second set of pins that are positioned horizontally to the first set. Both sets of pins must be accessed simultaneously by the correct key teeth combination.

### SUMMARY

In one aspect of the disclosure, a lock for pick prevention is provided. The lock includes a cylinder. A central axis of rotation is defined as passing through the longitudinal center of the cylinder. A set of cylinder pins are aligned in a row in the cylinder. A first carriage assembly is included. A first set of security pins are in the first carriage assembly. The first set of security pins are aligned to a keyed displacement in cooperation with the set of cylinder pins for rotational displacement of the cylinder. A second carriage assembly is positioned in an angular displacement around the central axis of rotation, relative to a position of the first carriage assembly. A second set of security pins is in the second carriage assembly. At least one of the second set of security pins is aligned to the same keyed displacement in cooperation with the cylinder as a corresponding one of the first set of security pins. An obstructive device is coupled to the second set of security pins. The obstructive device is disposed to obstruct the cylinder from reaching an unlocked position in an event, a displacement of the second set of security pins does not align with the same keyed displacement in cooperation with the cylinder as the first set of security pins.

In another aspect, a lock for pick prevention is provided. The lock includes a cylinder. A central axis of rotation is defined as passing through the longitudinal center of the cylinder. The cylinder includes a keyway. A set of cylinder pins are aligned in a row in the cylinder. A first set of security pins are aligned on a same plane as the keyway. The first set of security pins are aligned to a keyed displacement in cooperation with the set of cylinder pins in response to a key insertion in the keyway. A second set of security pins is angularly displaced from the keyway and aligned to the same keyed displacement in cooperation with the cylinder as the first set of security pins. An obstructive device is coupled to the second set of security pins. The lock is unlocked in response to the second set of security pins being displaced with the same keyed displacement as the first set of security keys and the second set of security pins are displaced after the first set of security pins are displaced. In addition, the obstructive device is disposed to obstruct the cylinder from reaching an unlocked position in an event, the displacement of the second set of security pins does not align with the same keyed displacement in cooperation with the cylinder as the first set of security pins.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a perspective, right side view of a lock assembly according to an illustrative embodiment of the subject technology.

FIG. 2 is an end view of the lock assembly of FIG. 1.

FIG. 3 is a left side view of the lock assembly of FIG. 1.

FIG. 4 is a plan view of the lock assembly of FIG. 1.

FIG. 5 is an enlarged perspective isolated view of a row of pins used in the lock assembly of FIG. 1 according to an illustrative embodiment of the subject technology.

FIG. 6 is a perspective side isolated view of a gate used in the lock assembly of FIG. 1 according to an illustrative embodiment of the subject technology.

FIG. 7 is a partial, perspective, left end view of the lock assembly of FIG. 1.

FIG. 8 is a partial, side perspective view of the right side of the lock assembly of FIG. 1.

FIG. 9 is a cross-sectional side view of the lock assembly of FIG. 1.

FIG. 10 is an isolated perspective, side view of a tumbler frame assembly of the lock assembly of FIG. 1.

FIG. 11 is a partial, top perspective, end view of the lock assembly of FIG. 1.

FIG. 12 is an enlarged isolated view of a second security pin assembly of the lock assembly of FIG. 1 according to an illustrated embodiment.

FIG. 13 is an enlarged side perspective view of an untriggered, trigger assembly for preventing unlocking of the lock assembly of FIG. 1, in the event of a picking attempt.

FIG. 14 is an enlarged side perspective view of a triggered state of the trigger assembly of FIG. 13, according to an illustrative embodiment.

FIG. 15 is an enlarged end view of the trigger assembly of FIG. 14.

FIG. 16 is a panned out end view of the trigger assembly of FIG. 15.

FIG. 17 is a partial, enlarged side view of a gear assembly connection to an alarm of the lock assembly of FIG. 1, according to an illustrative embodiment.

FIG. 18 is a partial, enlarged side view of an alarm of the lock assembly of FIG. 1, according to an illustrative embodiment.

FIG. 19 is an enlarged, partial view of the trigger assembly of FIG. 13.

FIG. 20 is a perspective, right side view of a lock assembly including a night latch system according to an illustrative embodiment.

FIG. 21 is a perspective end view of the lock assembly of FIG. 20.

FIG. 22 is a perspective left side view of the lock assembly of FIG. 20 without a knob.

FIG. 23 is a perspective end view of the lock assembly of FIG. 22.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, and referring to the Figures, illustrative embodiments of the subject lock provide a tumbler arrangement that includes two separate sets of pins that are engaged at different times. A key must satisfy the first set of pins and then rotate the cylinder to engage a second set of pins arranged identically to the first set of pins in order to unlock the device. The second set of pins are positioned angularly rotated from the first set of pins, relative to a central axis of the cylinder. If one tries to use lock picks, they are unlikely to maintain contact with the first set of pins while trying to pick the second set of pins as well. The second set of pins may be coupled to a bar or other trigger mechanism. If one or more of the second set of pins is not engaged correctly by the key, the trigger moves an obstructive element into a position blocking the cylinder from moving into the unlocked position.

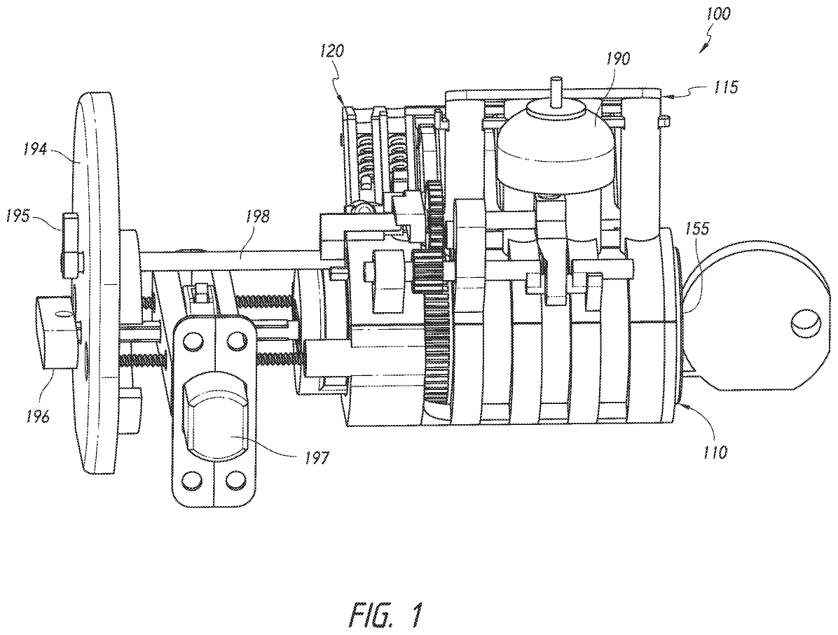

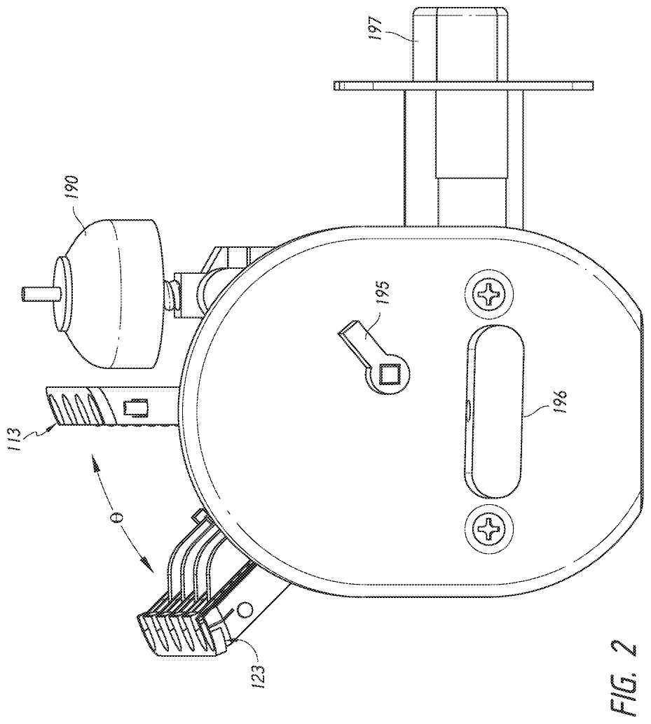

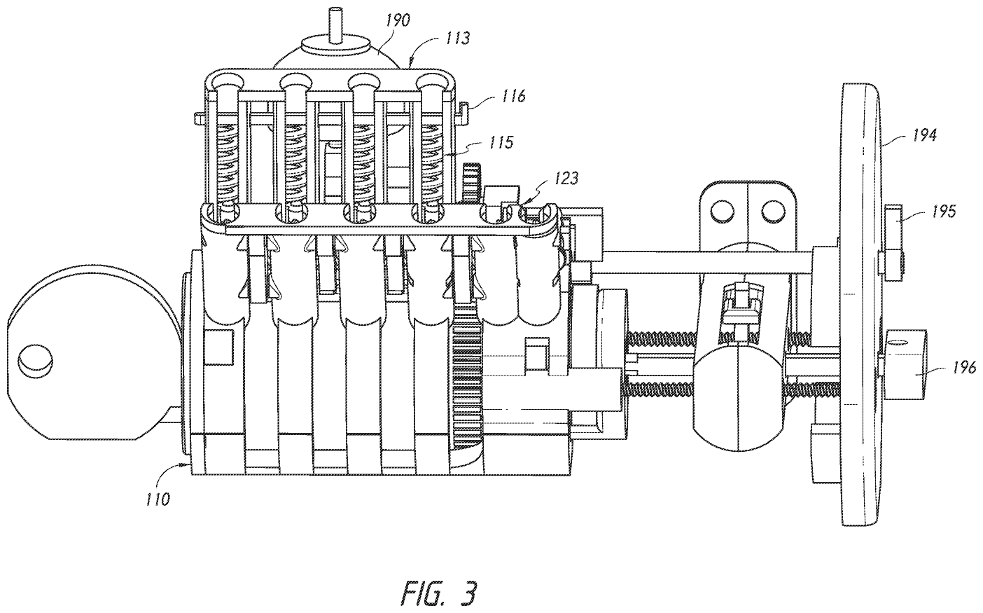

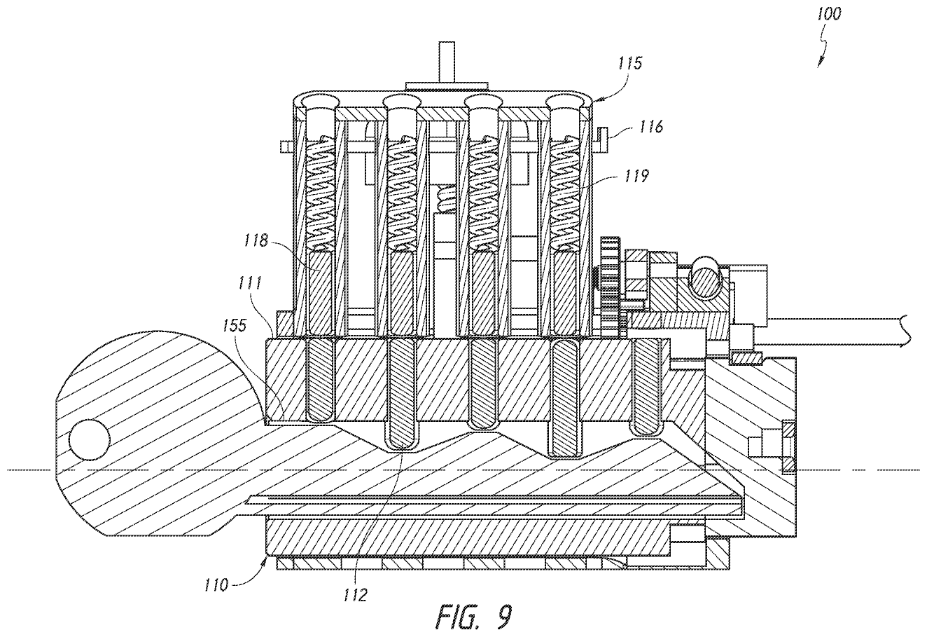

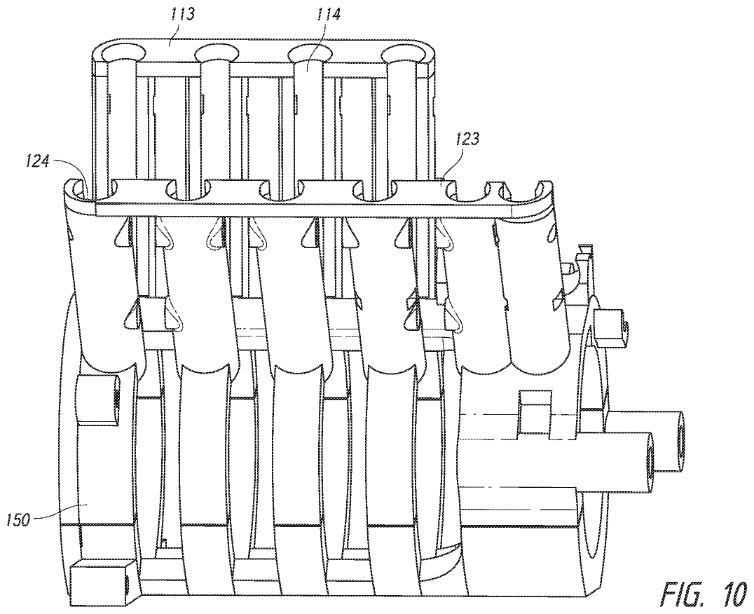

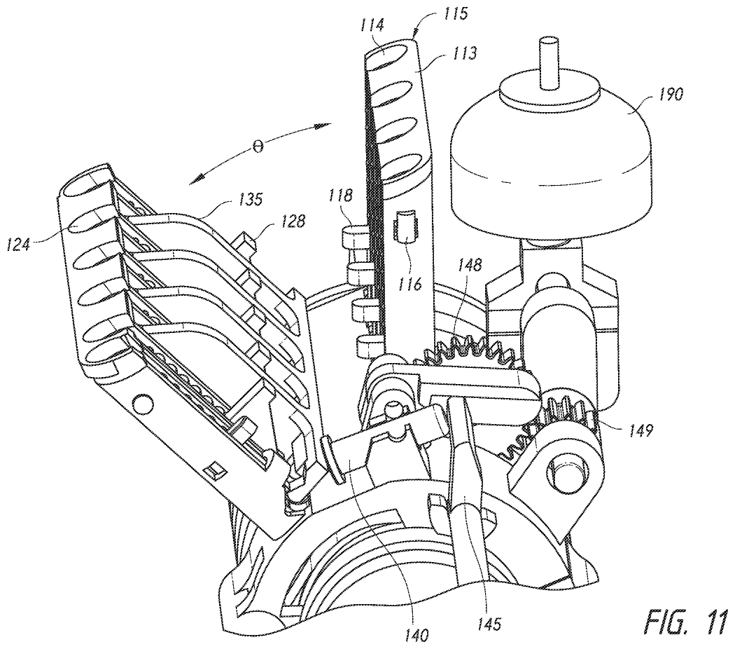

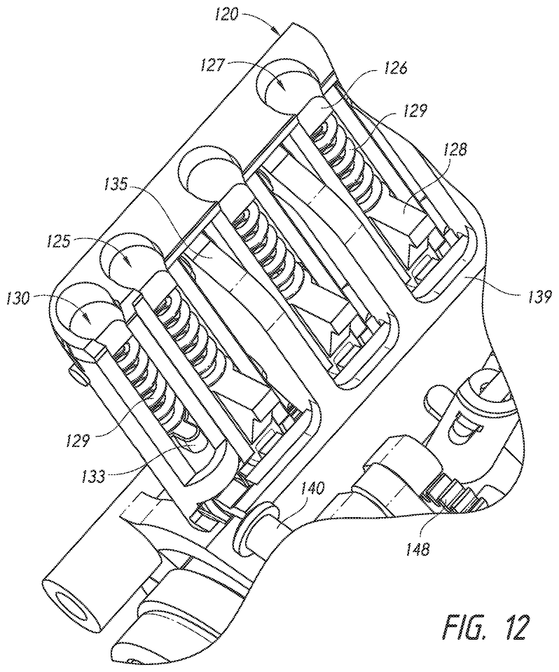

FIGS. 1-4 and 7-9 show a lock 100 according to an illustrative embodiment. The lock 100 generally includes a tumbler assembly 110. The tumbler assembly 110 is positioned inside a cylinder frame 150 (See FIG. 10). The tumbler assembly includes a cylinder 111, a first pin assembly 115, and a second pin assembly 120. The first pin assembly 115 may be aligned vertically with a keyway 155 (See FIGS. 1 and 9). A central axis of rotation is defined as passing through the longitudinal center of the cylinder 111. The first pin assembly 115 may be supported within a first pin carriage assembly 113. The second pin assembly 120 may be supported within a second pin carriage assembly 123. The second pin carriage assembly 123 may be offset from the first pin carriage assembly 113. For example, the second pin carriage assembly 123 may be positioned in an angular displacement around the central axis of rotation, relative to the position of the first carriage pin assembly 113. FIG. 2 (and FIG. 11) shows an angular displacement of approximately 30 degrees between the first pin carriage assembly 113 and the second pin carriage assembly 123. It will be understood that the second pin carriage assembly 123 is shown displaced according to an illustrative embodiment at an acute angle and in other embodiments, the angular displacement may be more or less than what is shown and in some embodiments obtuse and in a range between 1 degree and 180 degrees either clockwise or counterclockwise from a vertically positioned keyway 155.

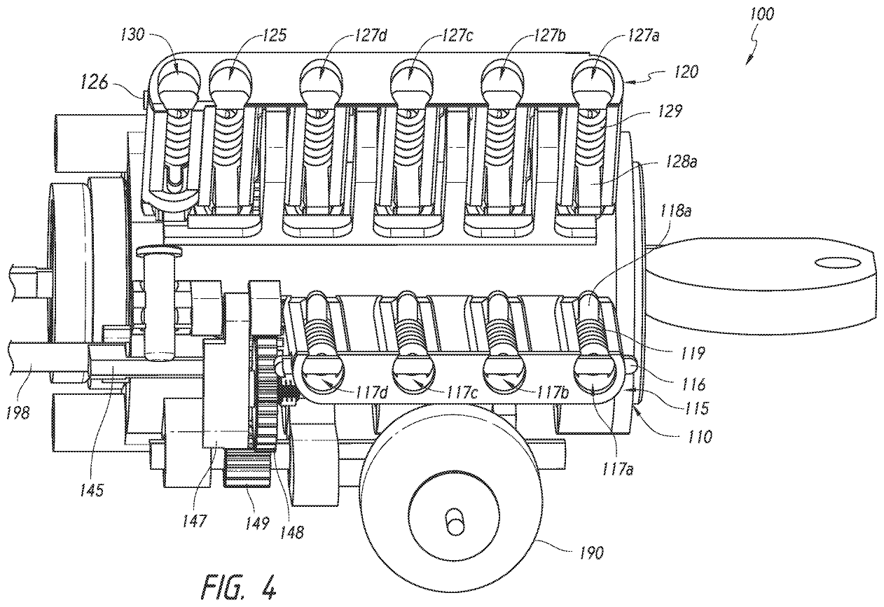

Referring to FIG. 4, the first pin assembly 115 includes a first set of pin systems 117 (labeled 117a-117d). The second pin assembly 120 includes a second set of pin systems 127 (labeled 127a-127d). The first set of pin systems 117 include pins 118 and a spring 119 over each pin 118. The second set of pin systems 127 include pins 128 and a spring 129 over each pin 128. The pins 118 are set vertically to cooperate with cylinder pins 112 (See FIG. 9) so that a keyed alignment of pins 112/118 are set to a sheer line with the cylinder 111. As is known in the art, when the pins 118 are displaced by a key to the correct height so that the sheer lien is unobstructed, the cylinder 111 may be rotated. In an illustrative embodiment, the second set of pin systems 127 may be arranged to replicate the same vertical alignment (for example, keyed displacement levels) as the pins 118. Some embodiments may use a one-to-one replica of keyed displacements between pins 118a-118d to corresponding pins 128a-128d. In some embodiments, one or more of the pins 128a-128d may be present and set to the same height as a corresponding pin 118a-118d but not necessarily all pins 128 may be present.

In the illustrative embodiment shown, the second pin assembly 120 includes a fifth pin system 125 that includes a pin 127e. The cylinder 111 may have five cylinder pins 112 (as seen in FIG. 9) and the correct key will raise the full number of pins 112 to the correct height allowing the lock 100 to unlock. Some embodiments may include a height bar 116 that limits the height of all pins 112 in the first carriage assembly 113. As will be appreciated, the fifth pin 127e is invisible to a lockpicker when picking the first pin assembly 115. There being an additional pin 127 on the second pin assembly 120 should be seen as a way for a picker not to be able to determine the height of that pin during the pick attempt on the first pin assembly 115.

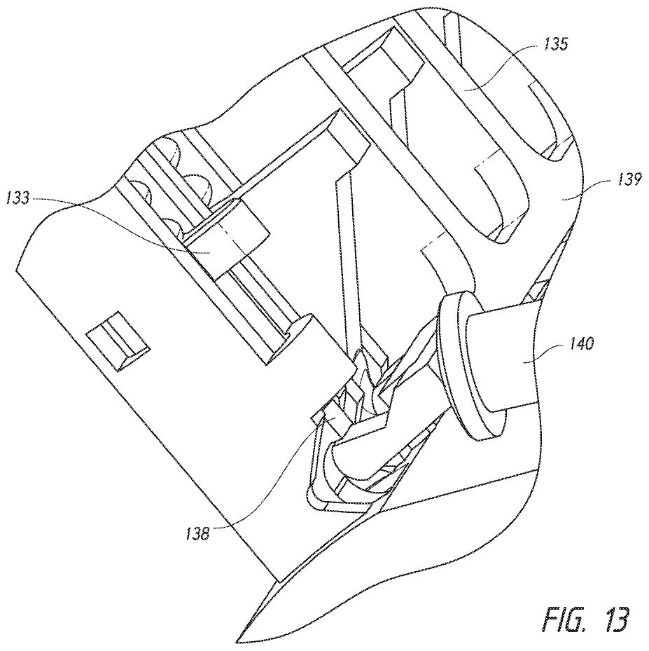

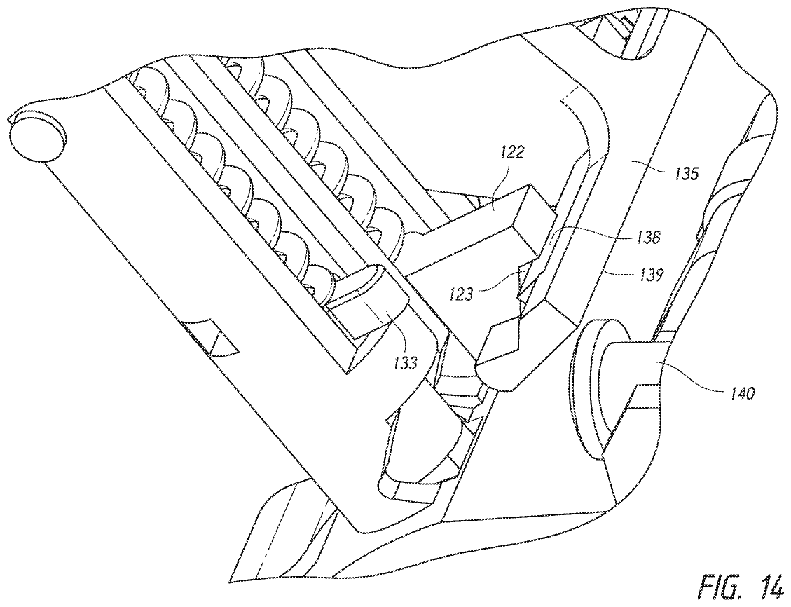

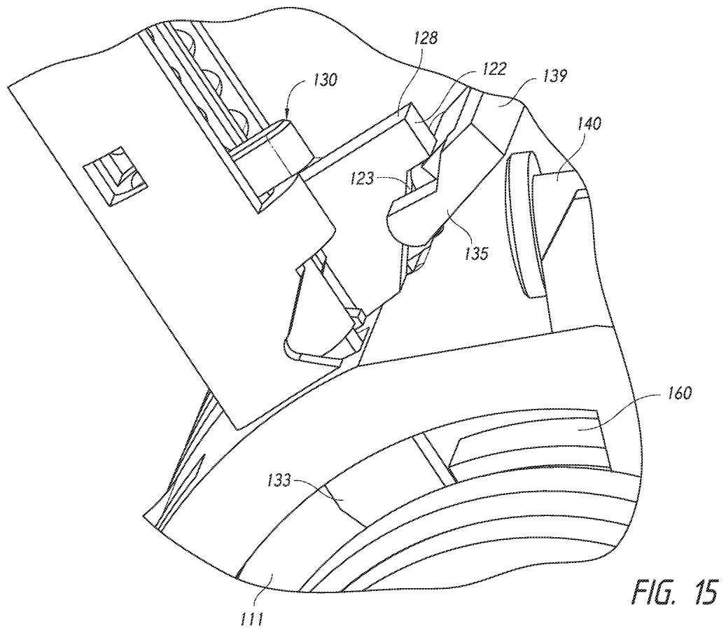

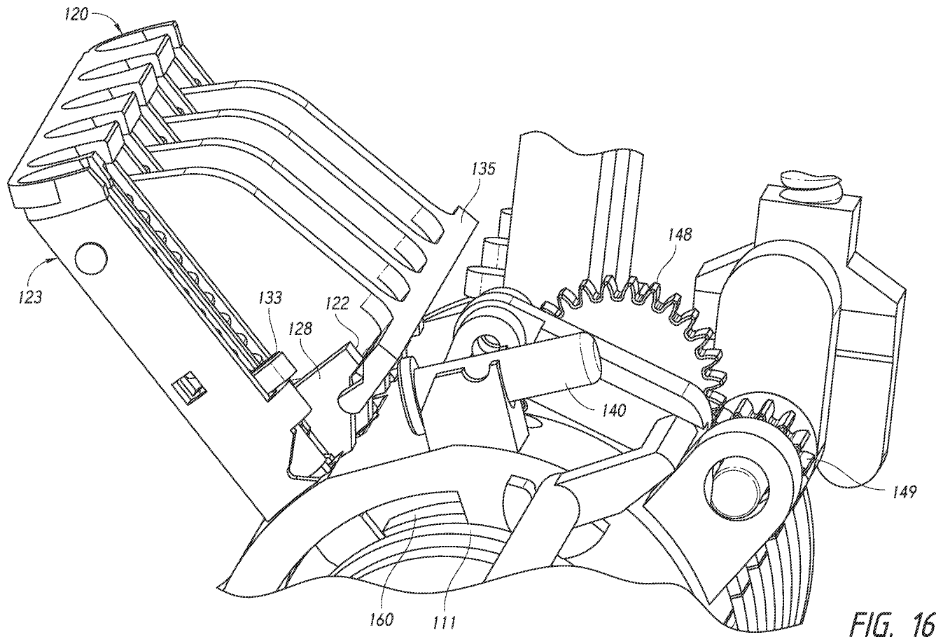

The second pin carriage assembly 123 may include a trigger pin assembly 130. The trigger pin assembly 130 may include a hammer pin 133 biased for downward movement by a spring 129. In an illustrative embodiment, the hammer pin 133 may by default, rest on the inner or top ledge of wall 139 of the gate 135 unless the gate 135 is already in an extended forward position, in which case the hammer pin 133 may be forced by the spring 129 to push into the cylinder 111. Embodiments include an obstruction preventing the cylinder 111 from rotating all the way to the unlocked position. For example, referring to FIGS. 13-15, the cylinder may include a detent 160 aligned with the hammer pin 133. In an illustrative embodiment, the detent 160 is a protrusion that projects out from the top surface of the cylinder 111 and is elongated for an arc section of the cylinder 111. This kind of detent may provide reinforcement from attempts to use brute force the lock 100 open since the body of the detent 160 is substantially long. Other embodiments of the detent 160 may include for example, a tab or a slot into which the bottom of the hammer pin 133 may project into.

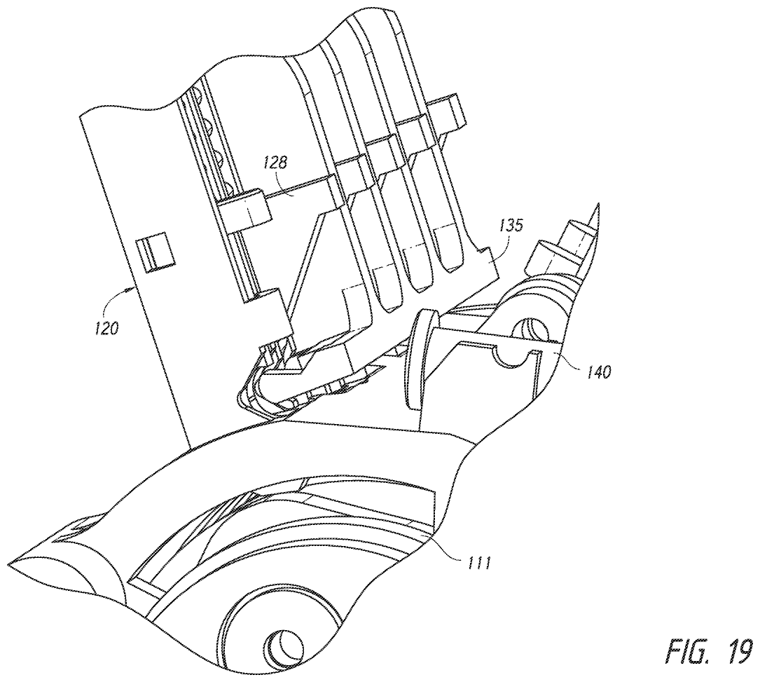

In general, to open the lock 100, a key with a proper tooth configuration is inserted into the keyway 155 wherein the cylinder pins 112 engage the teeth. Assuming a proper key is inserted, the cylinder sheer line requirement is met with the first set of pin systems 117, and the cylinder 111 is rotated. In the illustrative embodiment shown, the key would engage the second set of pin systems 127 after having engaged the first set of pin systems 117. The same key would then displace the pins 128 to meet the sheer line requirement to keep the cylinder 111 rotating until the lock 100 is in the unlocked state. FIG. 19 shows an example of the second pin assembly 120 and cylinder 111 position in an untampered state.

As will be appreciated, the illustrative arrangement may thwart lock picking attempts since a lock pick is unlikely to maintain the pin displacement after the first set of pin systems 117 are satisfied. Once the cylinder 111 rotates (usually by virtue of a tensioner without the pick), there is nothing maintaining pressure against the cylinder pins 112 when the cylinder pins 112 reach the second set of pin systems 127. At least one or more of the pins 128 are likely to fall into the space in the keyway 155 when the tensioner or other pick is rotated into the line with second the set of pin systems 127. When one of the pins 128 is incorrectly displaced, a trigger system may be actuated moving an obstructive element (for example, the detent 160) into the cylinder 111's rotation path preventing unlocking of a deadbolt 197 (or other detent such as a shackle).

Accordingly, even if a lock picker successfully rotates the cylinder 111 to the second pin assembly 120 with the first four pins 127 in keyed alignment with the cylinder pins 112, the picker is unaware of the presence of the additional pin 127e. Regardless of whether the picker knows an additional pin 127 is present, the likelihood of maintaining the correct cylinder pin displacement for all the pins 112 including the additional pin requirement is substantially low, and it becomes more likely that one or more of the pins 127 (and especially the pin 127e), is incorrectly displaced triggering the hammer pin 133 into engagement with the detent 160.

Referring to FIG. 5, an example of a pin 128 is shown according to an illustrative embodiment. The pin 128 may include a head 122 and a sloped indent 121. Some embodiments may include a cam surface 123 on the front side and under the pin head 122. The indents 121 may couple with a surface on the gate 135 or other edge while the pin(s) 128 are in position awaiting to receive a key. If a pin 128 is displaced in response to an incorrect key displacement, the bar or other edge may be displaced causing a pin(s) 128 to drop triggering the trigger pin assembly 130 and means to obstruct the unlocking path to prevent further rotation of the cylinder 111.

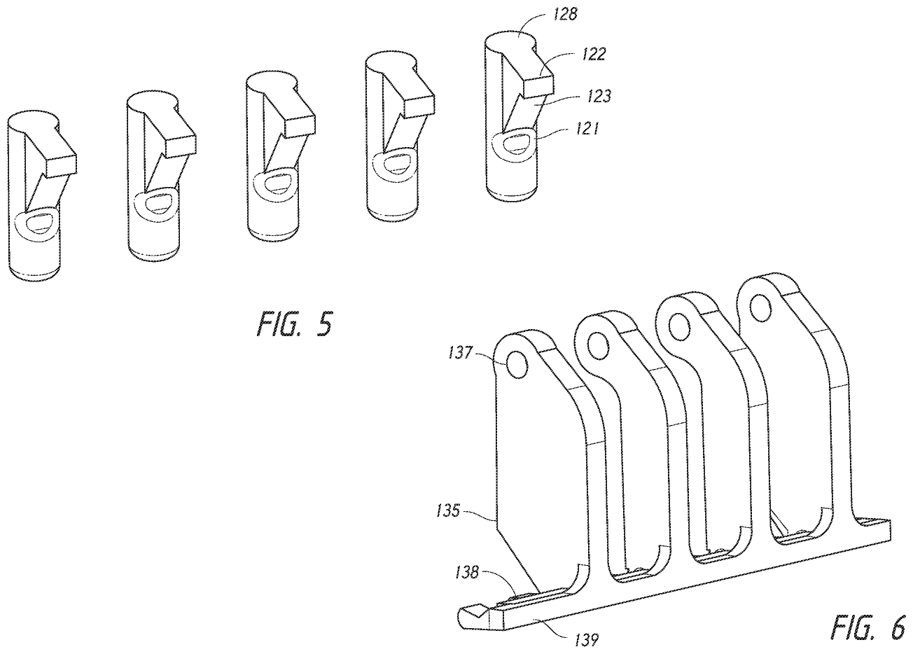

Referring now to FIG. 6, a gate 135 is shown. The gate 135 may be coupled to or housed in the second pin carriage assembly 123 using a rod threaded through holes 137. See also FIGS. 2, 7, 8, and 11. The gate 135 may be positioned in front of the second pin assembly 120. In some embodiments, the pin heads 122 may project through slots in the gate 135. The gate 135 may include a wall 139 which may be positioned on a bottom edge of the gate. A rear edge of the wall 139 may include a gate cam surface 138 disposed to receive the cam surface 123 of any pin 128. Referring back to FIG. 19 temporarily. The gate 135 is shown in its default, untriggered position in abutment with the hammer 140.

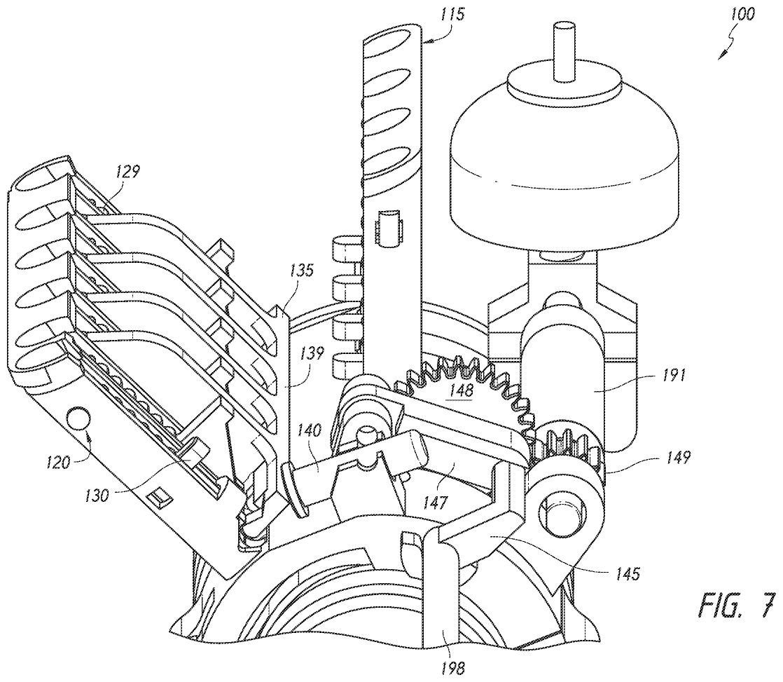

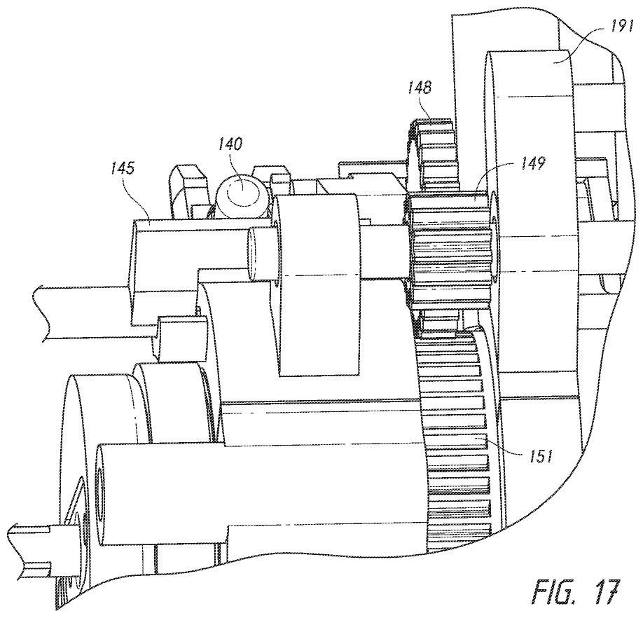

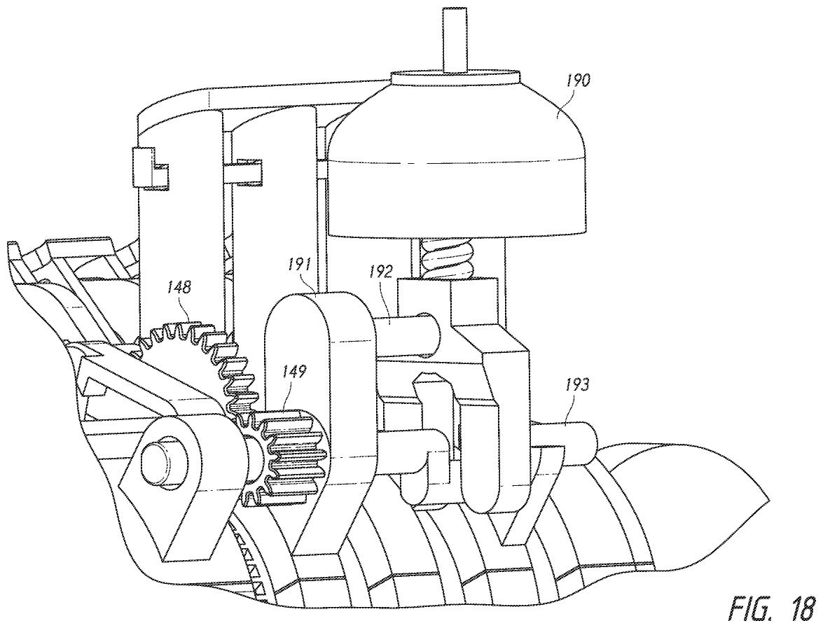

Referring now to FIGS. 7, 8, and 17, the lock 100 is shown in a tampered state according to an illustrative embodiment. In an untampered state, a hammer 140 may be positioned in abutment with the bottom edge wall 139. In the event of a pick attempt pr other tampering, one or more of the pins 128 have been displaced. The pin(s) 128 drop down and the cam surface 123 of the displaced pin 128 engages with the cam surface 138 of the gate 139. The lock 100, having triggered tamper protection as a result of one of the pins 128 being displaced, may move the gate 135 into the hammer 140, which in turn may collide into or push a swing arm 145. The swing arm 145 may rotate forward (shown as left to right). The movement of the swing arm 145 may actuate a connecting arm 147 that sets into motion a set of gears 148, 149, and 151. Arm 191 may be coupled to gear 149. Actuation of arm 191 may move rod 192 and rocker 193, coupled to an alarm 190, which may be set off by the initial displacement of the gate 135 and movement of the intervening elements.

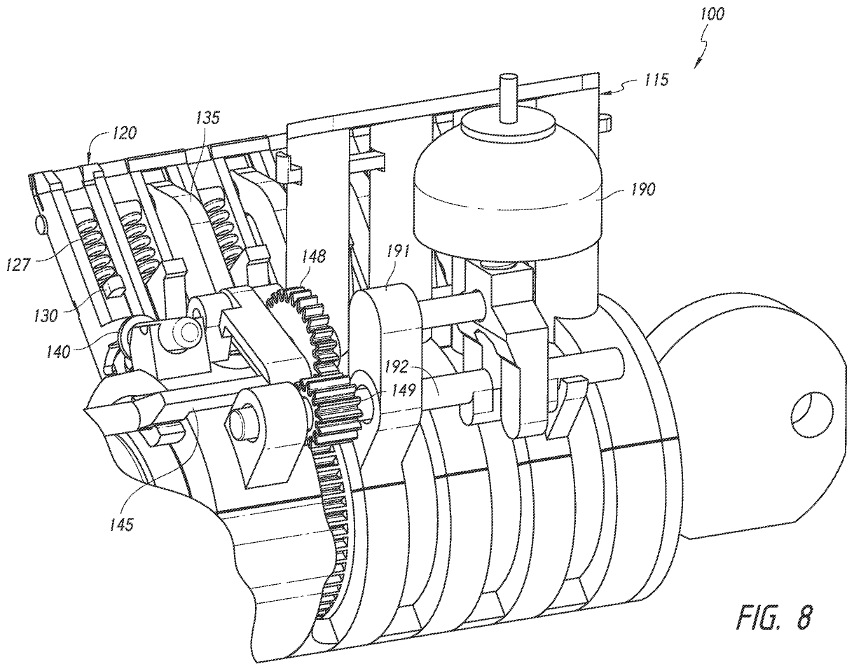

Referring back to FIGS. 1-4 along with FIGS. 7 and 8, some embodiments include a reset latch 195 on an indoor side faceplate 194 coupled to the swing arm 145. For example, one end of a bar 198 may be connected to the swing arm 145. The other end of the bar 198 may be connected to the reset latch 195. Some embodiments may include manual locking latch 196 on the indoor side of the faceplate 194.

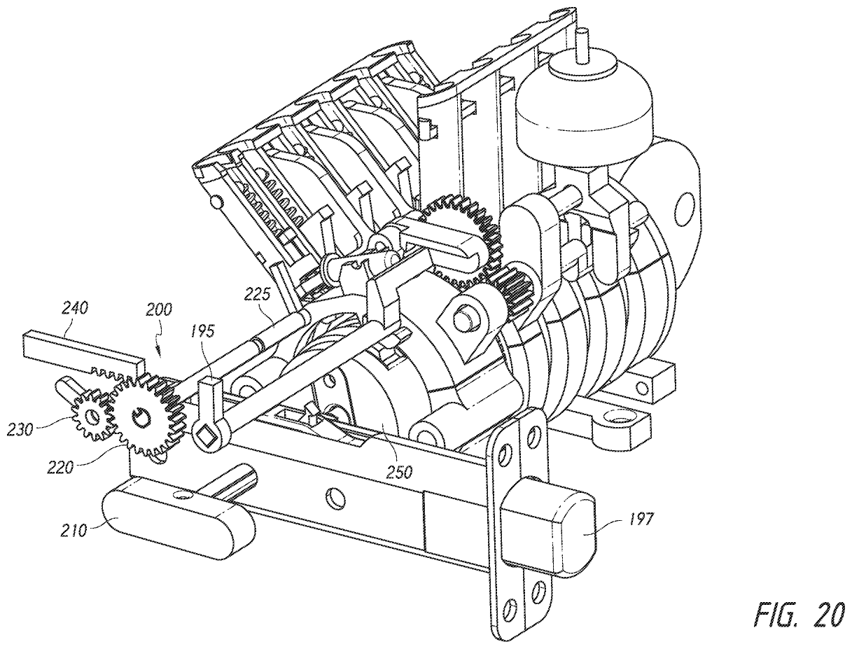

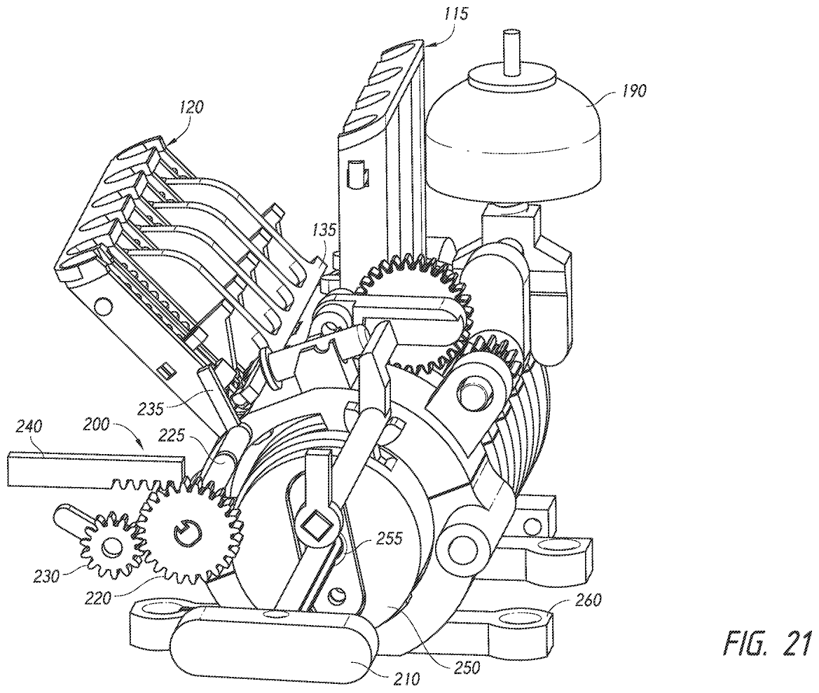

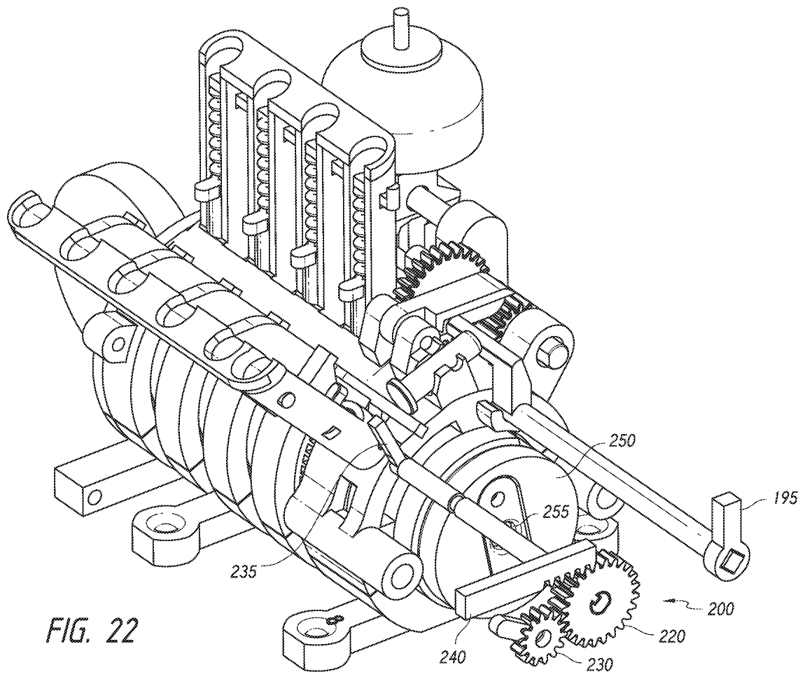

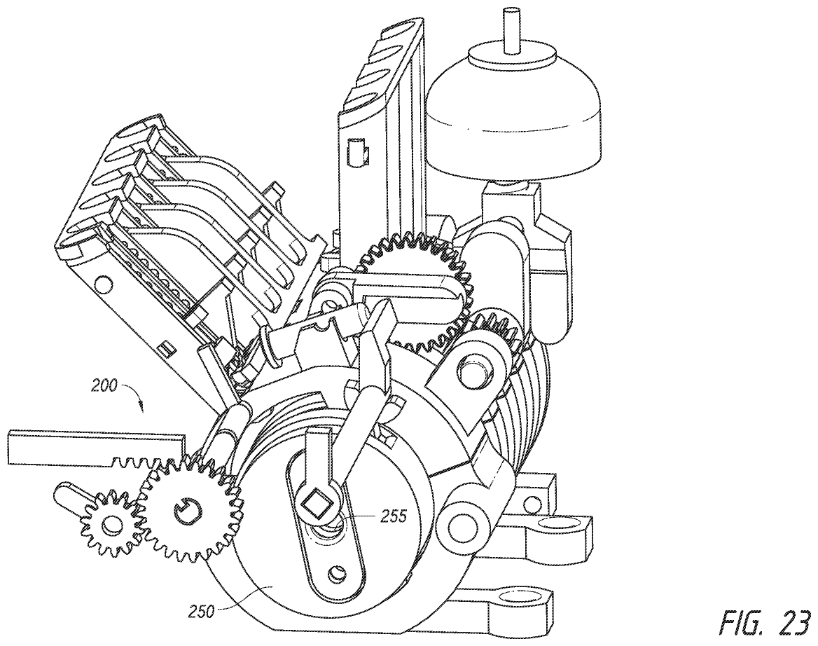

Referring now to FIGS. 20-23, some embodiments include a night latch system 200. The night latch system 200 is generally configured to provide a manual override of the lock from an interior of the room. A user may engage the night latch system 200 to prevent the lock from being opened by someone on the exterior of the room. In general, the cylinder 111 is prevented from rotating when the night latch system 200 is engaged. The night latch system 200 may include for example, a latch 225 that includes a catch or lever 235 on a distal end. The catch or lever 235 may be disposed to engage the gate 135 when the latch 225 is turned (or otherwise operated). When the catch or lever 235 engages the gate 135, the gate 135 may be pushed forward and the hammer pin 133 may be pushed forward into the cylinder 111 (See FIG. 9) positioned within housing 250, similar to the operation involved in obstructing the cylinder 111 from rotating when an unsuccessful lock pick attempt is performed as described above. For sake of illustration, the drawings do not show a handle or button on the proximal end of the latch 225. However, it should be understood that a handle or button is present an attached to one of the triggering mechanisms for operation of the latch 225. Embodiments may include for example, a gear-based trigger for rotating the latch 225. Two different types of gear systems are shown; a spur gear and a rack and pinion system. However, only one type of gear system is generally present in the night latch system 200. For a spur gear type system, a handle may be coupled to spur gear 230, which when rotated, engages spur gear 220 that is coupled to the shaft of latch 225. The rotation of spur gear 220 rotates the latch 225 into or out of engagement with the gate 135 consequently, setting the cylinder 111 into a locked mode or an unlocked mode. In a rack and pinion type system, a linear gear 240 (rack) is moved which is coupled to the gear 220. The translation of movement in the linear gear 240 rotates the gear 220 which causes the latch 225 to lock or unlock the cylinder 111 as described above.

Some embodiments of the lock include a deadbolt latch 210 coupled to the deadbolt 197 for manual locking and unlocking of the deadbolt 197. The shaft of the deadbolt latch 210 travels through the deadbolt assembly (in contact with the deadbolt 197) and connects in to a receptacle 255 in the end of the housing 250. Turning the deadbolt latch 210 moves the deadbolt 197 linearly forward and backward to secure the deadbolt 197 into a doorjamb as is known in the art.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A lock for pick prevention, comprising:
a cylinder, wherein a central axis of rotation is defined as passing through the longitudinal center of the cylinder;
a set of cylinder pins aligned in a row in the cylinder;
a first carriage assembly;
a first set of security pins in the first carriage assembly, wherein the first set of security pins are aligned to a keyed displacement in cooperation with the set of cylinder pins for rotational displacement of the cylinder;
a second carriage assembly, wherein the second carriage assembly is positioned in an angular displacement around the central axis of rotation, relative to a position of the first carriage assembly;
a second set of security pins in the second carriage assembly, wherein at least one of the second set of security pins is aligned to the same keyed displacement in cooperation with the cylinder as a corresponding one of the first set of security pins; and
an obstructive device coupled to the second set of security pins, wherein the obstructive device is disposed to obstruct the cylinder from reaching an unlocked position in an event, a displacement of the second set of security pins does not align with the same keyed displacement in cooperation with the cylinder as the first set of security pins.

2. The lock of claim 1, wherein the cylinder pins must be rotated with the cylinder after satisfying the keyed displacement with the first set of security pins, and engage the second set of security pins after an engagement with the first set of security pins.

3. The lock of claim 1, wherein each pin in the second set of security pins is positioned in a same keyed displacement height from the cylinder as a corresponding pin in the first set of security pins.

4. The lock of claim 1, wherein the angular displacement of the second carriage assembly from the first carriage assembly is in a range of 1 degree to 89 degrees or 91 degrees to 179 degrees.

5. The lock of claim 1, further comprising a keyway in the cylinder, wherein the keyway is configured to accept a set of teeth on a key, positioned on a single edge of the key.

6. The lock of claim 1, further comprising a reset lever coupled to the second set of security pins, wherein an actuation of the reset lever mechanically resets the second set of security pins to a default keyed alignment.

7. The lock of claim 1, further comprising an alarm coupled to the second set of security pins, wherein the alarm is triggered in response to the obstructive device obstructing the cylinder from reaching the unlocked position.

8. The lock of claim 1, further comprising a night latch coupled to the cylinder, wherein the night latch is configured to engage the obstructive device to prevent the cylinder from moving from a locked to an unlocked position.

9. A lock for pick prevention, comprising:
a cylinder, wherein a central axis of rotation is defined as passing through the longitudinal center of the cylinder;
a keyway in the cylinder;
a set of cylinder pins aligned in a row in the cylinder;
a first set of security pins aligned on a same plane as the keyway, wherein the first set of security pins are aligned to a keyed displacement in cooperation with the set of cylinder pins in response to a key insertion in the keyway;
a second set of security pins, wherein the second set of security pins is angularly displaced from the keyway and aligned to the same keyed displacement in cooperation with the cylinder as the first set of security pins; and
an obstructive device coupled to the second set of security pins, wherein:
the lock is unlocked in response to the second set of security pins being displaced with the same keyed displacement as the first set of security keys and the second set of security pins are displaced after the first set of security pins are displaced, and
the obstructive device is disposed to obstruct the cylinder from reaching an unlocked position in an event, the displacement of the second set of security pins does not align with the same keyed displacement in cooperation with the cylinder as the first set of security pins.

10. The lock of claim 9, wherein the cylinder pins must be rotated with the cylinder after satisfying the keyed displacement with the first set of security pins, and engage the second set of security pins after an engagement with the first set of security pins.

11. The lock of claim, 10 wherein the angular displacement of the second set of security pins from the first set of security pins is in a range of 1 degree to 180 degrees.

12. The lock of claim 9, wherein each pin in the second set of security pins is positioned in a same keyed displacement height from the cylinder as a corresponding pin in the first set of security pins.

13. The lock of claim 9, wherein the keyway is configured to accept a set of teeth on the key, positioned on a single edge of the key.

14. The lock of claim 9, further comprising a reset lever coupled to the second set of security pins, wherein an actuation of the reset lever mechanically resets the second set of security pins to a default keyed alignment.

15. The lock of claim 9, further comprising an alarm coupled to the second set of security pins, wherein the alarm is triggered in response to the obstructive device obstructing the cylinder from reaching the unlocked position.

16. The lock of claim 9, further comprising further comprising a night latch coupled to the cylinder, wherein the night latch is configured to engage the obstructive device to prevent the cylinder from moving from a locked to an unlocked position.
